(19) United States
(12) Patent Application Publication
(10) Pub. No.: US 2015/0378864 A1
(43) Pub. Date: Dec. 31, 2015

(54) SYSTEMS AND METHODS FOR INSTRUMENTING APPLICATIONS FOR PERFORMANCE MONITORING

(71) Applicant: SmartBear Software, Inc., Beverly, MA (US)

(72) Inventors: Ole Lensmar, Stockholm (SE); Abraham Nevado, Boca Raton, FL (US)

(21) Appl. No.: 14/748,821

(22) Filed: Jun. 24, 2015

Related U.S. Application Data
(60) Provisional application No. 62/016,846, filed on Jun. 25, 2014.

(51) Int. Cl. G06F 11/34

(52) U.S. Cl. CPC G06F 11/3476; G06F 11/3414

(57) ABSTRACT

Provided herein are systems and methods for instrumenting scripts of webpages. An agent may intercept a webpage served by an origin server to a client responsive to receiving a request for the webpage from the client. The agent may insert an instrumentation script within a portion of the webpage prior to execution of the one or more scripts of the webpage. The instrumentation script may be configured to instrumentation script configured to embed instrumentation code within the one or more scripts to report on execution of one or more scripts. Upon the client loading the webpage received from the agent, the instrumentation script may be executed on the client and embed the instrumentation code within the one or more scripts. The data may be stored to one of a log file or a server to report on execution of the one or more scripts of the webpage.

### CROSS-REFERENCE TO RELATED PATENT APPLICATIONS

This application claims priority to and the benefit of U.S. Provisional Application No. 62/016,846, entitled “Systems and Methods for Instrumenting Applications for Performance Monitoring” and filed on Jun. 25, 2014, which is incorporated herein by reference in its entirety for all purposes.

### FIELD OF DISCLOSURE

The present application is generally directed to systems and methods for application performance monitoring, and in particular, to the installation and deployment of instrumentation code for JavaScript on web pages, web servers, and Java-based mobile applications.

### BACKGROUND

Web and mobile applications are becoming more complex. Such applications may have many application programming interfaces and may include multiple scripts, such as libraries and scripts from a multitude of third parties. This complexity can make it challenging to monitor and debug such applications, especially during run-time when these applications are in operation. Sometimes it is challenging to monitor and debug mobile applications for which you do not have the source code. Furthermore, some of the application tools, such as rich Internet Application and HTML5 are moving logic from server side to client side, generating new challenges from performance monitoring and debugging point of view. Another challenge is the process of installing debugging agents for applications that are in operation. For example, to install a java agent in an application server requires modification of the application server startup script and restart the application server to take effect. Restarting an application server that is in operation or for every time you want to monitor and debug the application may not be desired.

### SUMMARY

One aspect of the present solution is generally directed to automatically injecting JavaScript monitoring JavaScript in Java and .NET environments and more generally speaking any multipurpose JavaScript and to monitor performance of JavaScript with JavaScript code including JavaScript objects through monkey patching and prototype redefinition. The present solution allows to transparently instrument JavaScript code. An agent (e.g., server agent) can be deployed in a server side application or the application server. The deployed agent can cascade information up to end user device where the executed JavaScript, even JavaScript downloaded from third party webpages, is monitored and performance sent back to a server. The server agent is configured to inject JavaScript instrumentation code into served pages that contain JavaScript. This instrumentation code dynamically modifies the existing client-side JavaScript code in each page and adds tracing and backend-reporting capabilities.

By way of example, the work flow for injecting such instrumentation code by the server agent into client-side web pages may be as follows. An agent is installed in the application server. A user of a web application performs an HTTP GET. The GET arrives to the application server, the logic is executed and the HTML created. The HTML created is sent to the user, but the installed server agent intercepts and parses this HTML and adds JavaScript call to a JavaScript library on any JavaScript block. The HTML arrives to the end user. The end device downloads the instrumentation JavaScript and starts loading normally every JavaScript block. At every block of JavaScript, including those referring to third party libraries like jQuery, the instrumentation library is invoked. Instrumentation library is able to execute instrumentation through a technique referred as “monkey patching” for every method.

The instrumentation functions or method looks for all the variables defined in the JavaScript block, and replaces with a wrapper function the call to any local function. The wrapper function contains a generic structure of type:

i. Mark_MethodStart

ii. Execute original Function

iii. Mark_MethodEnd

The above method allows monitoring plain JavaScript functions. However calls to JavaScript Objects are not so direct, as the monitored object prototype are modified before they are executed. To instrument JavaScript objects, the lookup of for the variables defined in the JavaScript block (as described above) returns references to constructors. In case an object constructor is found, instead of just monkey patching through the object constructor, the prototype of the object is scanned and every function defined in the prototype replaced by a Wrapper function.

In another aspect, the present solution is directed to installing an agent, such as the above-mentioned server agent, to a running application server without restarting the application server. The present allows to deploy a standard Web application Archive (WAR) in any Java Web Application container without the need of restarting the application (“app”) server or modifying any of the startup scripts directly or indirectly. This dramatically improves installation process of java agents, and avoids disruption times in production application servers.

By way of example, the work flow for installing a java agent, such as the server agent described above, may be as follows. Application server is started and some classes have already been loaded. A user decides to instrument the application server. The user stores the Web Application Archive or WAR file in the application server deployment folder to install the instrumentation agent, such as a server agent. The application server identifies reads and processes the WAR file. The WAR file contains a Context Listener and a standard Startup servlet 155 registered in the application web.xml file. The Startup servlet 155 is then invoked by Application Container to get a temporal folder to extract the agent jar file in a known location, creates a subfolder in the known location, and includes all the required resources and sets any required or desired environmental variables. The installation process is configured to copy, extract, or move all the content to be included in one single file to minimize installation complexity. The Servlet 155 gets the application server process identifier (PID) using Java Management Extension (JMX) and Java Virtual Machine (JVM) methods. The Servlet 155 uses the PID to invoke the HotSpot method to attach to the running method, such as com.sun.tools.attach.VirtualMachine.attach(PID) and loads the agent using the path to the created folder above, such as by using VirtualMachine.loadAgent(pathToExtractedAgent).

Once the agent is loaded in the virtual machine (VM), the agent can start transforming new classes. The agent includes a hook in the MANIFEST.MF to notify agentmain method. This method is called when agent is started which creates a thread that runs in the background (LoaderThread). Agent is registered as retransform capable agent. The running thread (LoaderThread) scans through the instrumentation mechanism for all loaded classes (getAllLoadedClasses) and fires through the instrumentation API a retransform of all those classes. The WAR file also includes environmental variables to detect if the WAR file has been uninstalled. Agent checks these variables to assure WAR file has not been uninstalled. In case war file is uninstalled, the instrumentation transformer is removed, and a new retransform is thrown for all loaded classes. Thanks to this, bearing in mind agent was registered as retransformable, the original code is replaced back to memory.

In a further aspect, the present solution addresses instrumenting mobile application for which the source code is not available or readily available or to manually instrumenting source code when the code is available. The tool of the present solution performs the following steps to instrument a compiled mobile application, such as one compiled from Java classes into an Android operating system application. The present solution dynamically converts the android .dex (Dalvik Executable) files back to Java classes and inspects these classes to allow the user to select which classes to instrument. Once the classes to instrument are selected, the tool of the present solution dynamically generates the appropriate aspects for instrumentation of the application and then applies or weaves that aspect into the extracted java classes. The tool then compiles the source code to bytecode and packages the classes back to a .dex and/or APK file. This allows the present solution to bypass the need for accessing the source code of the solution and provides the user with an instrumented application that reports and desired/configured profiling information back to a reporting server. At least one aspect of the present solution is directed to a method of instrumenting scripts of webpages. The agent may intercept a webpage served by an origin server to a client responsive to receiving a request for the webpage from the client. The webpage may comprise one or more scripts. The agent may insert an instrumentation script within a portion of the webpage prior to execution of the one or more scripts. The instrumentation script may be configured to embed instrumentation code within the one or more scripts to report on execution of one or more scripts. The instrumentation script may be executed on the client, upon the client loading the webpage received from the agent. The instrumentation scrip may embed the instrumentation code within the one or more scripts. The one or more script may via executing of the embedded instrumentation code store data to one of a log file or a server to report on execution of the one or more scripts of the webpage. In some embodiments, the agent resides on one of the origin server, the client or a server intermediary to the client and the origin server. In some embodiments, the instrumentation code may be configured to provide one or more of tracing, debugging, profiling, performance measurement and data logging of the one or more scripts.

In some embodiments, the agent may determine that at least one packet of one or more packets of traffic originating from the origin server to the client satisfies a filter condition, In some embodiments, intercepting the webpage may further comprise intercepting the webpage, responsive to determining that the at least one packet of the one or more packets of the traffic satisfies the filter condition.

In some embodiments, the agent may determine that the one or more scripts of the webpage includes at least one pre-existing script block. In some embodiments, the instrumentation code may be embedded in the at least one pre-existing script block, the instrumentation script configured to compile one of an inline source or source file of the at least one pre-existing script block before execution of the at least one pre-existing script block.

In some embodiments, the instrumentation code may be configured to initialize one or more parameters specific to the client, the webpage, the origins server, or the agent. In some embodiments, executing the instrumentation script further may comprise parsing the webpage to identify the one or more scripts and interpreting the one or more scripts, responsive to identifying the one or more scripts.

In some embodiments, interpreting the one or more scripts may further comprise identifying a namespace of the respective script in which the instrumentation code is to be called. In some embodiments, interpreting the one or more scripts may further comprise responsive to identifying the namespace, replacing a function in the namespace with a wrapper function to call the function, and to record an end time of execution. The wrapper function may be configured to record a start time of execution.

In some embodiments, executing the instrumentation script may further comprise detecting the one or more scripts included in the webpage, for each of the one or more scripts, detecting a type of the respective script, and embedding instrumentation code only within respective scripts of a specified type. In some embodiments, storing the data may further comprise storing the data, responsive to determining an occurrence of a triggering event. The triggering event may indicate execution of the one or more scripts. In some embodiments, instrumentation code may be embedded within one or more pre-existing script block that specify an external source file by retrieving the external source file and embedding the instrumentation code into the external source file.

At least one aspect of the present solution is directed to a system for instrumenting scripts of webpages. The system may comprise an agent. The agent may be configured to intercept a webpage served by an origin server to a client, responsive to receiving a request for the webpage from the client. The webpage may comprise one or more scripts. The agent may be configured to insert an instrumentation script within a portion of the webpage prior to execution of the one or more scripts. The instrumentation script may be configured to embed the instrumentation code in the one or more scripts to report on execution of the one or more script. The instrumentation script may be configured to be executed by the client upon loading of the webpage to embed the instrumentation code within the one or more scripts. The instrumentation code may be configured upon execution to store data to one of a log file or a server to report on execution of the one or more scripts of the webpage.

In some embodiments, the agent may be further configured to execute on one of the origin server, the client or a server intermediary to the client and the origin server. The instrumentation code may be configured to provide one or more of tracing, debugging, profiling, performance measurement and data logging of the one or more scripts.

In some embodiments, the agent may be further configured to determine that at least one packet of one or more packets of traffic originating from the origin server to the client satisfy a filter condition. In some embodiments, intercepting the webpage may further comprise intercepting the webpage, responsive to determining that the at least one packet of the one or more packets of the traffic satisfies the filter condition.

In some embodiments, the instrumentation script may be further configured to determine that the one or more scripts of the webpage includes at least one pre-existing script block and embed the instrumentation code in the at least one pre-existing script block. In some embodiments, the instrumentation script may be configured to compile one of an inline source or source file of the at least one pre-existing script block before execution of the at least one pre-existing script block.

In some embodiments, the instrumentation script may further be configured to initialize one or more parameters specific to the client, the webpage, the origins server, or the agent. In some embodiments, the instrumentation script may be further configured to parse the webpage to identify the one or more scripts and interpret the one or more scripts, responsive to identifying the one or more scripts.

In some embodiments, the instrumentation script may further be configured to interpret the one or more scripts by identifying a namespace of the respective script in which the instrumentation code is to be called and responsive to identifying the namespace, replacing a function in the namespace with a wrapper function. The wrapper function may configured to record a start time of execution, to call the function, and to record an end time of execution.

In some embodiments, the instrumentation script may further be configured to detect the one or more scripts included in the webpage, for each of the one or more scripts, detecting a type of the respective script, and embed the instrumentation code only within respective scripts of a specified type. In some embodiments, one of the instrumentation script or instrumentation code may be configured to store the data responsive to determining an occurrence of a triggering event. The triggering event may indicate execution of the one or more scripts. The instrumentation script may further be configured to embed the instrumentation code within one or more pre-existing script blocks that specify an external source file by retrieving the external source file and embedding the instrumentation code in the external source file.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1 is a block diagram of an embodiment of a network environment for one or more clients connecting to a server via a network;

FIG. 2 is a flow diagram depicting an embodiment of a method for injecting instrumentation code into scripts of a web page;

FIG. 3 is a flow diagram depicting an embodiment of a method for deploying an agent in an application server; and

FIG. 4 is a flow diagram depicting an embodiment of a method for injecting instrumentation code into a compiled mobile application.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for injecting a performance code to instrumentation code in scripts of a web page;
Section C describes embodiments of systems and methods for deploying an agent in an application server while the application server is running; and
Section D describes embodiments of systems and methods for instrumenting mobile applications.

### A. Network and Computing Environment

Prior to discussing the specifics of embodiments of the systems and methods of the present solution it may be helpful to discuss the network and computing environments in which such embodiments may be deployed.

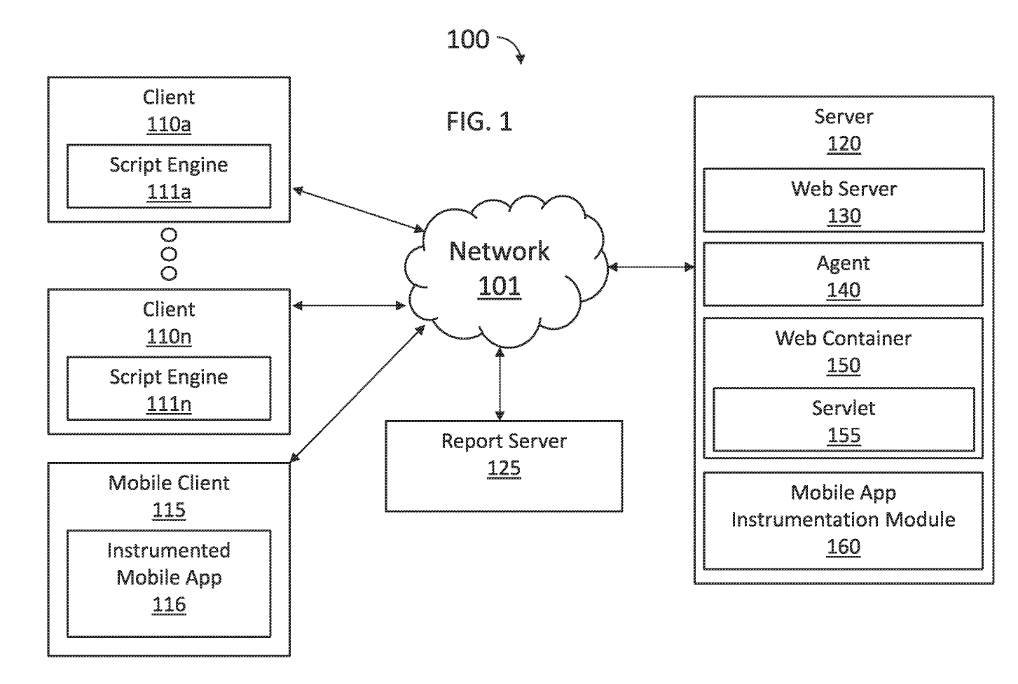

FIG. 1 is a block diagram of an embodiment of a network environment 100 for practicing embodiments of the present solution. The network environment 100 includes a network 101, one or more clients 110a-110n (generally referred to as clients 110) including a mobile client 115, a server 120, and a report server 125.

The network 101 may be any type or form of network and may include a plurality of networks. The network 101 may be one or more of local area network, a wide area network, a data communication, or the Internet. The network 101 may connect via a plurality of wired and wireless connections. The network 101 may be private or public or a combination of private and public networks. Computing devices may communicate over the network 101 via one or more protocol stacks, such as the TCP/IP stack. Computing devices may be identified by an address, such as an IP address, and/or universal resource locator (URL).

The client 110 may be a personal computer, a laptop, a desktop, a tablet, a smart TV, a smart phone, a gaming console, a set top device, or any other type and form of computing device. A computing device may include one or more processors and memory. The memory may store instructions that may be executed by the one or more processors. The client 110 may run an operating system. The client 110 may connect to the network 111 via a network card over a wired or a wireless connection. The client 110 may include one or more applications that may communicate to the server 120 over the network 101 via any type and form protocols. The application may be a user agent or a web browser.

A computing device may be used for practicing an embodiment of a client 110, mobile client 115, a server 120, or a report server 125. A computing device may include a central processing unit (CPU) and a main memory unit. The CPU may also include one or more cache. A computing device may include input and output devices, such as a visual display device, a touch screen, a keyboard, and a pointing device.

The CPU is any logic circuitry that responds to and processes instructions fetched from the main memory unit. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device may be based on any of these processors, or any other processor capable of operating as described herein.

Main memory unit may be one or more memory chips capable of storing data and allowing any storage location to be directly accessed by the microprocessor, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory may be based on any of the above described memory chips, or any other available memory chips capable of operating as described herein. The processor communicates with main memory via a system bus (described in more detail below).

The main processor communicates directly with cache memory via a secondary bus, sometimes referred to as a backside bus. In other embodiments, the main processor communicates with cache memory using the system bus. Cache memory typically has a faster response time than main memory and is typically provided by SRAM, BSRAM, or EDRAM. In some embodiments, the processor communicates with various I/O devices via a local system bus 150. Various busses may be used to connect the central processing unit 101 to any of the I/O devices, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor may use an Advanced Graphics Port (AGP) to communicate with the display. In some embodiments, the main processor communicates directly with I/O device via HyperTransport, Rapid I/O, or InfiniBand. In some embodiments, local busses and direct communication are mixed: the processor communicates with I/O device using a local interconnect bus while communicating with I/O device directly.

The computing device may support any suitable installation device, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any application, agent, or portion thereof. The computing device may further comprise a storage device, such as one or more hard disk drives or redundant arrays of independent disks, for storing an operating system and other related software, and for storing application software programs such as any program related to the application or the agent. Optionally, any of the installation devices could also be used as the storage device. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device may include a network interface to interface to a Local Area Network (LAN), Wide Area Network (WAN) or the Internet through a variety of connections including, but not limited to, standard telephone lines, LAN or WAN links (e.g., 802.11, T1, T3, 56kb, X.25), broadband connections (e.g., ISDN, Frame Relay, ATM), wireless connections, or some combination of any or all of the above. The network interface may comprise a built-in network adapter, network interface card, PCMCIA network card, card bus network adapter, wireless network adapter, USB network adapter, modem or any other device suitable for interfacing the computing device to any type of network capable of communication and performing the operations described herein.

A wide variety of I/O devices may be present in the computing device. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller. The I/O controller may control one or more I/O devices such as a keyboard and a pointing device, e.g., a mouse or optical pen. Furthermore, an I/O device may also provide storage and/or an installation medium for the computing device. In still other embodiments, the computing device may provide USB connections to receive handheld USB storage devices.

In some embodiments, the computing device may comprise or be connected to multiple display devices, which each may be of the same or different type and/or form. As such, any of the I/O devices and/or the I/O controller may comprise any type and/or form of suitable hardware, software, or combination of hardware and software to support, enable or provide for the connection and use of multiple display devices by the computing device. For example, the computing device may include any type and/or form of video adapter, video card, driver, and/or library to interface, communicate, connect or otherwise use the display devices. In one embodiment, a video adapter may comprise multiple connectors to interface to multiple display devices. In other embodiments, the computing device may include multiple video adapters, with each video adapter connected to one or more of the display devices. In some embodiments, any portion of the operating system of the computing device may be configured for using multiple displays. In other embodiments, one or more of the display devices may be provided by one or more other computing devices, such as computing devices and connected to the computing device, for example, via a network. These embodiments may include any type of software designed and constructed to use another computer's display device as a second display device for the computing device. One ordinarily skilled in the art will recognize and appreciate the various ways and embodiments that a computing device may be configured to have multiple display devices.

In further embodiments, an I/O device may be a bridge between the system bus and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device typically operates under the control of an operating system, which controls scheduling of tasks and access to system resources. The computing device can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS 8, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system, or any type and/or form of a Unix operating system, among others.

In other embodiments, the computing device may have different processors, operating systems, and input devices consistent with the device. Moreover, the computing device can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

The computing device may comprise multiple processors and may provide functionality for simultaneous execution of instructions or for simultaneous execution of one instruction on more than one piece of data. In some embodiments, the computing device may comprise a parallel processor with one or more cores. In one of these embodiments, the computing device is a shared memory parallel device, with multiple processors and/or multiple processor cores, accessing all available memory as a single global address space. In another of these embodiments, the computing device is a distributed memory parallel device with multiple processors each accessing local memory only. In still another of these embodiments, the computing device has both some memory which is shared and some memory which can only be accessed by particular processors or subsets of processors. In still even another of these embodiments, the computing device, such as a multi-core microprocessor, combines two or more independent processors into a single package, often a single integrated circuit (IC). In yet another of these embodiments, the computing device includes a chip having a CELL BROADBAND ENGINE architecture and including a Power processor element and a plurality of synergistic processing elements, the Power processor element and the plurality of synergistic processing elements linked together by an internal high speed bus, which may be referred to as an element interconnect bus.

In some embodiments, the processors provide functionality for execution of a single instruction simultaneously on multiple pieces of data (SIMD). In other embodiments, the processors provide functionality for execution of multiple instructions simultaneously on multiple pieces of data (MIMD). In still other embodiments, the processor may use any combination of SIMD and MIMD cores in a single device. In some embodiments, the computing device may comprise a graphics processing unit. In one of these embodiments, the computing device includes at least one central processing unit and at least one graphics processing unit. In another of these embodiments, the computing device includes at least one parallel processing unit and at least one graphics processing unit.

The application, such as a browser, may be or may include a script engine 111a-111n (generally referred to as 111). The script engine may comprise a program, library, application, script, service, process, task or set of executable instructions to execute, operate or run one or more scripts. The script engine 111 may receive from the server 120 a script to execute. The received script may be referred to as client-side script. The script may be written in a programming or scripting language, such as JavaScript, ActionScript, or any other implementation of the EMCAScript Language specification, or Java. The script may be embedded inside of a web page that is written in a markup language, such as HTML or HTML5. The script engine 111 may be a virtual machine that interprets and/or executes the script. The script engine 111 may be a Java Virtual Machine or a JavaScript engine.

The mobile client 115 may be a type of a client 110 that is portable or mobile. The mobile client 115 may be a smart phone or any other computing device that includes one or more processors and memory that store instructions executed by the one or more processors. The mobile client 115 may include an operating system, such as Android OS, iOS, BlackBerry OS, or Windows Phone OS. The operating system may include a kernel, such as a Linux kernel. The operating system may include drivers, libraries, runtime, and virtual machines. The operating system may include a networking driver that connects to the network 101 and enables communication with the server 120 and/or the report server 125. The mobile client 115 may include application framework and one or more applications. The one or more applications may include a package manager, an application installer, or any other applications. The one or more applications may be in machine code or in bytecode.

An application on the mobile client 115 may be an instrumented mobile app 116. The instrumented mobile app 116 may be an application that has been instrumented by a mobile app instrumentation module 160. The instrumented mobile app 116 may be include one or more instrumentation instructions that sends a report to the report server 125 or stores a log in the memory of the mobile client 115. The instrumentation instructions may correspond to one or more objects or functions. The instrumented mobile app 116 may report profiling, performance, trace and debugging information.

The server 120 may be a computing device including one or more processors and memory. The server 120 may be a plurality of servers. The plurality of servers 120 may be a logical group of servers, such as a server farm or cluster. In some of these embodiments, the plurality of servers 120 may be geographically dispersed and/or utilize a heterogeneous set of operating system. The server 120 may provide an application or service to one or more clients 110, including mobile clients 115. The service provided by the server 120 may include a web service, a FTP service, a secure shell service, a virtual private network service, a graphical desktop sharing service, a file service, a print service, or any other type and form service. The server 120 may include a web server 130, an agent 140, a web container 150, and a mobile app instrumentation module 160.

The web server 130 may serve a web page to one or more clients 110, including mobile clients 115. The web server 130 may also be referred to as an application server. The web server 130 may provide a web page that is written in a markup language that includes a scripting language. The web page and/or the scripts embedded in the web page may be dynamically generated by server-side programming or scripting languages, such as Java, Ruby, PHP, Node.JS, or Python. The web server 130 may execute on a virtual machine. The web server 130 may be deployed via a web application archive (WAR). The web server 130 may include, manage, notify, or invoke the agent 140, the web container 150, or the mobile app instrumentation module 160.

The agent 140 may be an application, program, library, script, process, task, service or set of executable instructions executing on a device and designed and constructed to install instrumentation code into web pages and scripts of the web page. The agent 140 may be deployed on or with the web server 130. The agent 140 may instrument the web server 130. The instrumentation mechanism, when executed by the web server 130, may report profiling, tracing, debugging, performance and data logging information to the server 120 or the report server 125. The agent 140 may be executed on a virtual machine. The agent 140 may be configured to transform or retransform Java classes in order to or to include instrumentation code. The agent 140 may intercept response from a server 120 to the client 110.

The web container 150 may be a component of the web server 130. The web container 150 may also be referred to as an application container 150. The web container 150 may load one or more WAR files that contain servlets 155. The web container 150 may manage one or more servlets 155. A servlet 155 may be an application that may extend the capabilities of the web server 130. The agent 140 may be a servlet 155 or be loaded by a servlet 155. The web container 150 may detected when a WAR file is removed or uninstalled.

The mobile app instrumentation module or tool 160 may be an application, program, library, script, task, process or executable instructions executing on a device, such as the server or client. The mobile app instrumentation module 160 may receive a mobile application to instrument. The mobile application may be sent from a client 110 or a mobile client 115, or selected on the server 120. In some implementations, source code to be instrumented may be received. The mobile app instrumentation module 160 may inject, install, place, or deploy instrumentation code into selected classes or parts of selected classes. In some implementations, the source code for the received mobile application may not be available, and only the bytecode or the machine code may be received. In such implementations, the mobile app instrumentation module 160 may decompile the bytecode or machine code of the received mobile application into classes. The mobile app instrumentation module 160 may then inject, install, place, or deploy instrumentation code into selected classes or parts of selected classes. The mobile app instrumentation module 160 may recompile the instrumented code into bytecode or machine code. In some implementations, the instrumented application may be packaged into an installation file and transmitted to the mobile client 115 to be installed. In some implementations, the mobile app instrumentation tool 160 may inject, install, place, or deploy instrumentation code into an application based on a policy or based on an account information.

The report server 125 may be a server to receive, process and aggregate communications from any instrumentation code installed, injected or deployed on web pages, web servers and/or mobile applications. The instrumentation code may include or incorporate and report to the report server 125 information about, on or resulting from code tracing, debugging and exception handling, profiling, performance counters and computer data logging. The report server 125 may store the reported information from the instrumentation code to a database and provide a user interface to generate reports and dashboard to view the information.

B. Systems and Method for Injecting Instrumentation Code into Client-Side Scripts of a Web Page

One aspect of the present solution is directed towards client-side code instrumentation of scripts on web page to provide instrumentation, such as tracing, debugging, profiling and to measure performance metrics. A web server 130 may respond to a query from a client 110 for a web page by serving or sending a web page that contains or loads one or more scripts, such as third party scripts or pre-existing script blocks. An agent 140 may intercept the web page and insert or inject one or more scripts or script blocks before being transmitted to the client 110. The added script blocks, when executed on the client, further instrument the scripts or script blocks referenced, included or embedded in the web page. The instrumentation code is executed by the client 110 and a report is sent back to a report server 125.

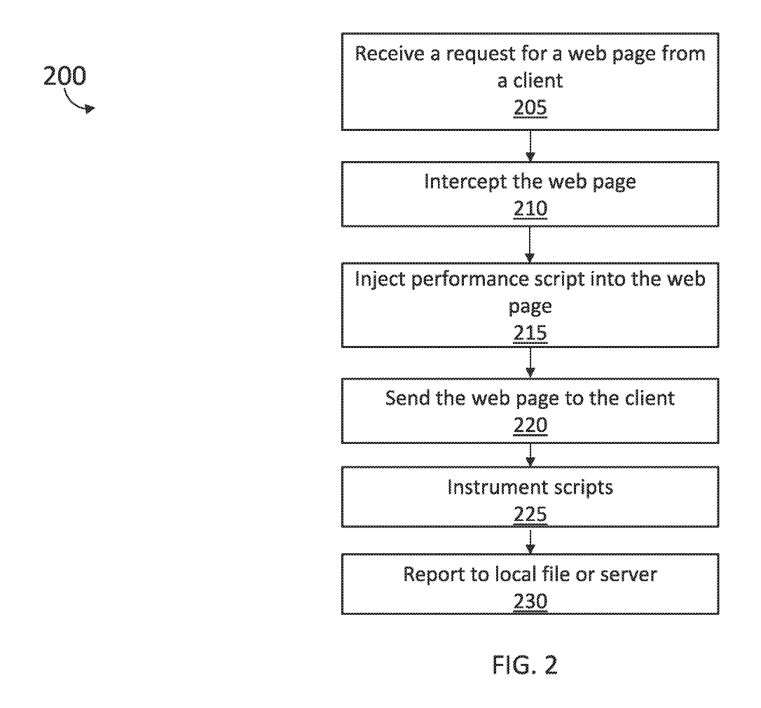

Referring now to FIG. 2, an embodiment of a method for injecting instrumentation code into a web page for reporting is shown. In brief overview, the method generally includes receiving a request for a web page from a client 110 (step 205), intercepting the web page (step 210), and injecting performance script into the web page (step 215). The method further includes sending the web page to the client 110 (step 220), executing the performance script to instrument scripts on the web page (step 225), and reporting to local file or server 125 (step 230).

The web server 130 receives a request for a web page from a client 110 (step 205). The request for a web page may be received over a TCP/IP stack. The request may be a HTTP GET request or a HTTP POST request. The request may be received by a web server 130 or an application server. The web server 130 may respond to the request by creating a web page. The web page may be dynamically generated responsive to the request. The web page may be created from an existing web page and may include one or more scripts. The scripts may be designed and configured to execute on a client device. The web page may include one or more client-side scripts or scripts that execute on the client, such as by a use agent or browser upon loading of the web-page. The web server 130 may send the created web page to the client 110.

An agent 140 intercepts a web page (step 210). The agent may intercept one or more packets of a web page at any layer in the network stack, such as the application layer, transport layer or network layer. The agent 140 may be executing on the web server 130. The agent 140 may be part of the web server. The agent may execute on a server that hosts or executes an application or web application. The agent 140 may be executing on a different server or virtual machine from the web server 130 servicing the request. Intercepting the web page may include monitoring the outbound traffic of a web server 130 and determining which packets of the outbound traffic should be intercepted, such as by using a filter. The filter may, for instance, specify one or more of a user, an IP address, a TCP port, a process ID, etc. Intercepting the web page may include an agent 140 that is registered as an event listener to a web server 130 response. In some implementations, the agent 140 may include an instance of a class that is registered as an event listener to a web server 130 response. In some implementations, the web page is only intercepted if the web page contains a script block.

The agent 150 injects, inserts or otherwise includes a performance or instrumentation script into the web page (step 215). The instrumentation script, sometime also referred to as a performance script, is designed, constructed and/or configured to deploy, insert, place or inject instrumentation code into a plurality of scripts, such as JavaScript which may be on or identified by a web page. The instrumentation script may modify scripts loaded into a browser or user agent to include, insert or embed within the web page instrumentation code for code tracing, debugging, profiling, performance measurements and data logging. Prior to injecting the performance or instrumentation script, the web page and/or the scripts on the web page may not be instrumented, or may lack other instrumentation scripts. For example, the web page and/or scripts may be the original web pages and scripts established and/or provided by the publisher or owner of the web site, such as those web pages and scripts served by the origin server without instrumentation. Such web pages and scripts may not have any instrumentation to provide the functionality of the instrumentation script and methods and systems described herein.

In some implementations, a server agent 140 may inject, insert or otherwise include the performance script into the web page to be served to a client. In some implementations, the performance script may only be injected when the web page includes or references one or more scripts of pre-existing script blocks. Injecting the performance script may include inserting one or more script blocks of the performance script at the beginning of the web page, or before a first pre-existing script block of the web page. In some implementations, the performance script or one or more script blocks of the performance script are inserted at a point in the web page to be executed before any pre-existing script blocks or other scripts identified, referenced or loaded by the browser or user agent. In some implementations, the agent inserts or includes the performance script in a first portion of the web page such that the performance script is executed first or early in the web page loading process and prior to any scripts or other code to be instrumented by the performance script.

The instrumentation script may specify or comprise an instrumentation source file that specifies one or more classes, prototypes, and functions, such as to implement the functionality of the instrumentation script and/or embed the instrumentation into the other scripts. The instrumentation script may include or specify a uniform resource locators that has or specifies the one or more classes, prototypes and functions to provide or perform the instrumentation, such as to the scripts on the web page. In some implementations, functions may include initialize function, decorators, and advices. In some implementations, another of the one or more script blocks may be an inline function call to a function specified in the instrumentation source file. In some implementations, the inline function call may be to an initialize function with parameters that are specific to the client 110, a user account, the web page, the web server 130, and/or the agent. For instance, the parameters may include a token uniquely identifying the web page or a servicing of the web page to the client 110, a transaction identifier, an agent name, and the URL of the web page. The initialize function may further include registering a send report function that is executed with the corresponding pre-existing script block finishes loading the web page including interpreting the one or more script blocks. In some implementations, each of the one or more inserted script blocks may specify a source file containing a JavaScript file.

The agent 140 may send the web page with the injected instrumentation script to the client 110 (step 220). Sending the web page may include sending a HTML file, such as an HTML file with scripts written in another language such as JavaScript. Sending the web page may also include sending one or more source files, including the instrumentation source file and one or more external source files. In some implementations, sending the web page may also include sending one or more style sheet files, such as a cascading style sheet file. Sending the web page to the client 110 may include sending the one or more files over a network 101 via a protocol stack.

A script engine 111 on the client 110, such as via the browser loads, processes and/or executes the performance script of the received web page to instrument one or more scripts loaded or identified by the web page (step 225). The browser or user agent may be or otherwise provide the script engine that executes scripts of a web page. As such, the browser or user agent may be configured to execute any one or more of the scripts on the web page, including the performance script. Instrumenting the script includes parsing content of the web page, such as HTML, identifying one or more script blocks or scripts included within the web page, and interpreting the one or more script blocks. Interpreting the one or more script blocks may include, for inline script block, interpreting the source code included or embedded within the HTML of a web page. Interpreting the one or more script blocks may further include, for script blocks referencing a source file, loading and parsing one or more referenced source files, such as the instrumentation source file and external source file. In some implementations, depending on the type of language and/or the type of engine used at the client 110, interpreting the one or more script blocks may include compiling the inline source and/or the source file before execution.

The performance script may detect one or more pre-existing script blocks or scripts within, on or referenced by the web page. For each of the one or more pre-existing script blocks, the type of the script may be detected, such as the type of language used to code the script (e.g., VBScript, JavaScript, etc). For instance, one of the pre-existing script blocks may specify a different scripting language. The method may include only instrumenting a pre-existing script block of a specified type, such as text/JavaScript. Instrumenting one or more pre-existing script blocks may include, for an inline script block, a call to a function that is defined in the instrumentation source file specified in one of the inserted script blocks. Instrumenting one or more pre-existing script blocks may include, for script blocks specifying an external source file, retrieving the external source file and injecting a call to a function in the instrumentation source file.

Instrumenting scripts by the performance script may further include interpreting or executing by the browser or user agent the first inserted script block of the web page (e.g., performance script), which may define one or more functions, variables, classes, primitives, and constants. One or more inserted inline script blocks of the performance script may call an initialization function. For each pre-existing script blocks in the web page, the performance script may interpret one or more inline script blocks and/or one or more external source files. The inline script blocks and/or the source files may be instrumented with a call to a function specified in the instrumentation source file. Interpreting the function specified in the instrumentation source file may include identifying a global namespace of the inline script block or the source file from which the function was called. The global namespace may be used to loop over each namespaces included in the global namespace. For each namespace, functions and objects under the namespace may be identified. Each function in each namespace is replaced or otherwise redefined with a wrapper function that wraps the corresponding function. The wrapper function, when executed, marks the start of the wrapper function, calls the corresponding function, and marks the end of the wrapper function. At the end of the wrapper function, one or more metrics may be stored in relation to the function, where the metrics include execution time and call stack. In some implementations, wrapping the functions may be performed using a technique referred to as “monkey patching.” Furthermore, for each object, the prototype of the object may be identified. Each function in the identified prototype may be replaced or redefined with a corresponding wrapper function. If another object is found within the object, the instrumentation is repeated recursively until an object with no prototype is identified. In some implementations, every function under every object in the global namespace may be replaced or redefined with a corresponding wrapper function.

The instrumentation code placed in the scripts by the performance script may report instrumentation information to a local file or server (step 230). In some implementations, upon loading the web page including executing all of the one or more script blocks, an event is triggered. The triggered event may invoke one or more event listeners, including one or more register functions. When executed, the register functions may report to a server the profiling metrics. In some implementations, the register functions may report to a local file. The profiling metrics may include execution time, call stack, URL, agent, etc.

This method allows the transparent instrumentation of client-side code that is sent with the web page by deploying an agent 140 to instrument the original web pages served by the origin server without changing such pages at the origin server. Performance of third-party web pages, to which source code may not be available, may be monitored and sent back to server. This method also avoids changing and maintaining instrumentation code at the origin server from which the web page is served. The method thus works with any webpages and client-side scripts without changes to the original webpage or website.

### C. Systems and Methods for Deploying an Agent for an Application Server

One aspect of the present solution is directed towards deploying an agent 140 on a web server 130 that is running, without restarting the web server 130 and/or modifying startup scripts of the web server 130. An agent 140 may be deployed on an application server while the application server is running. An installation archive file storing the agent 140 may be deployed on the application server. A startup servlet 155 stored in the archive file may then extract an instrumentation archive file and resources from the installation archive file to a temporary directory. The startup servlet 155 sets any desired or required environment variables and starts the instrumentation archive file. A main method of the agent in the instrumentation archive file is executed and attached to the application server. The agent 140 may be registered as a retransform capable agent, which may allow, enable or cause loaded classes to be retransformed.

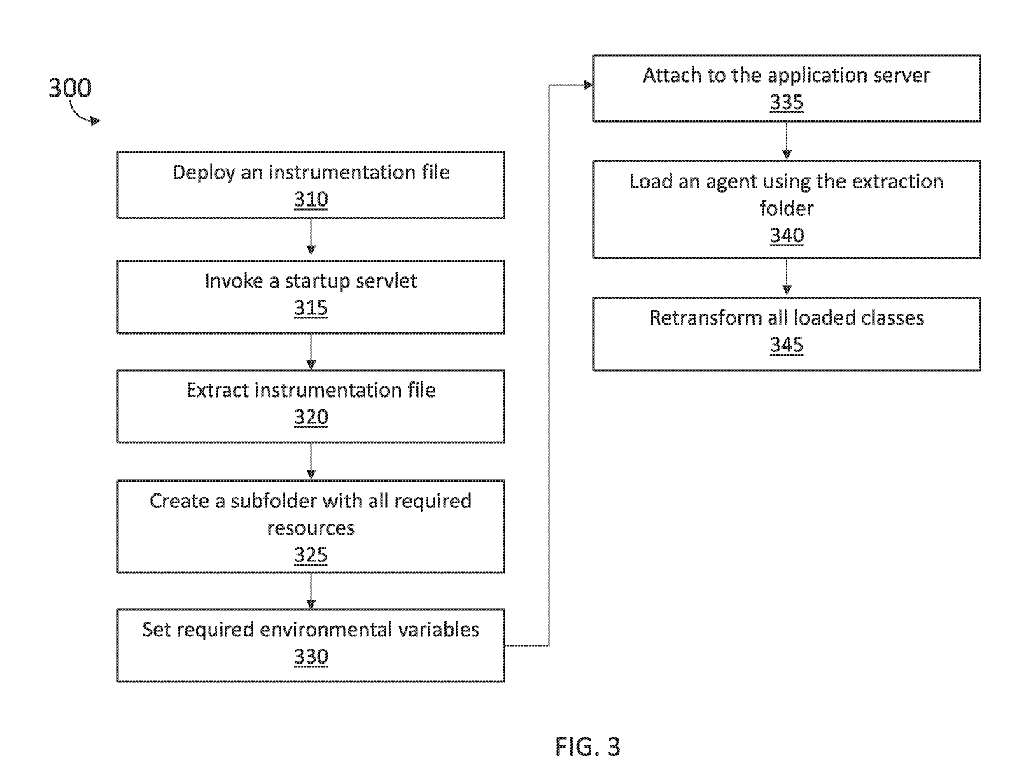

Referring now to FIG. 3, an embodiment of a method for deploying an agent 140 in an application or web server is shown. In brief overview, the method includes deploying A WAR file, that includes an instrumentation file or tool in the form of an agent (step 310), invoking a startup servlet 155 (step 315), and extracting the agent (step 320). The method further includes creating a subfolder with desired resources (step 325), setting environmental variables (step 330), and attaching to the application server (step 335). The method further includes loading an agent 140 using the extraction folder (step 340), and retransforming all loaded classes (step 340).

Still referring to FIG. 3, now in greater detail, an agent may be deployed to a running web or application server 130 (step 310). Deploying an agent includes deploying a Web application archive file in an application server deployment folder. The application server recognizes the deployment of the WAR file. Deploying the agent further includes deploying in an application server 130 that has already started and has already loaded a set of classes. In some implementations, deploying an agent further includes the application server identifying a standard context listener and a standard startup servlet 155 included in the web application archive. In some implementations, the web application archive may contain a manifest file and a deployment descriptor file, which may be an extensible markup language (XML) file.

A startup servlet 155 may be invoked by the web container 150 (step 315). The startup servlet 155 may also be referred to as an application container. The web container 150 may load the web application archive file. Invoking a startup servlet 155 may include invoking the startup servlet 155 that was identified in the web application archive. Invoking a startup servlet 155 may further include identifying and executing bytecode or source code inside the web application archive that corresponds to the startup servlet 155 as specified by the deployment descriptor file.

The servlet 155 extracts the agent, such an agent for instrumenting the web server or scripts on a web page (step 320). The startup servlet 155 may extract an agent from the web application archive. In some implementations, the agent file may be referenced by the deployment descriptor file. In some implementations, the agent file may be referenced within the startup servlet. The agent file may be extracted in a temporary folder. In some implementations, the temporary folder may be created in the same directory as the web application archive. The file or executable for the agent (e.g. agent file) may be an application archive, such as a Java Archive file. In some implementations, the application archive itself is not extracted, but the application archive is extracted from the web application archive. In some implementations, the temporary folder may be designated as the home folder.

The servlet 155 creates a subfolder with resources to be used or deployed (step 325). The subfolder may be a subfolder of the temporary folder. Creating a subfolder includes copying each resource file within the web application archive file to the subfolder. The directory structure of the resource files may be maintained.

The servlet 155 further includes setting environment variables (step 330). In some implementations, setting environment variables may include setting variables indicating installation directory and/or path. In some implementations, the variables may be system properties. In some implementations, variables may be set within a properties file. A variable may be, for instance, a Boolean variable that indicates whether the web application archive is loaded.

The agent 140 may be attached to the running web/application server (step 335). Attaching to the application server may include identifying a virtual machine that is running on the application server. In some implementations, the virtual machine may be identified by requesting a virtual machine manager for the name of a running virtual machine. In some implementations, the virtual machine manager may return a name that is then parsed to identify a process identifier of the virtual machine. In some instances, the process identifier may be a number. In some implementations, the application server process identifier may be identified via Java Management Extensions or Java Virtual Machine methods. The process identifier may be used to attach the servlet 155 to the virtual machine, such that the servlet 155 then has access to the virtual machine. In some implementations, the agent or virtual machine of/for the agent may be attached via a HotSpot method (e.g. VMcom.sun.tools.attach.VirtualMachine.attach(pid))

The servlet 155 loads the agent 140 using the extraction folder (step 340). The extraction folder, which is the temporary folder created in 320, may store the application archive file of the agent. Loading the agent 140 may include loading the application archive file. The application archive file may include a manifest file that specifies a hook to an agent main method. The application server, when loading the agent, may identify the hook to the agent main method and execute the agent main method. In some implementations, the application server may load the agent main method as a thread that runs in the background. In some implementations, loading the agent 140 further includes registering the agent 140 as retransform capable.

The agent and/or running thread retransforms loaded classes (step 345). The thread in the background, which is the agent main method, may instrument the already-loaded set of classes on the application server. Retransforming all loaded classes includes looping over each already-loaded class in the application server, and retransforming each class. Retransforming a class includes installing a new definition of the class which may be defined in the agent. The new definition of the class may be used by a compiler to generate a new bytecode of the class. In some implementations, only the already-loaded classes that have new definitions defined in the agent 140 may be transformed. Instead of looping through the already-loaded classes, the method may include looping through the classes that are defined in the agent 140. In some implementations, retransforming classes allows instrumentation of code, patching bugs, adding functionality, and code for tracing and performance metrics.

The WAR file also includes environmental variables to detect if the WAR file has been uninstalled. Agent checks this variables to assure WAR file has not been uninstalled. In case WAR file is uninstalled, the instrumentation transformer is removed, and a new retransform is thrown for all loaded classes. As agent was registered as retransformable, the original code is replaced back to memory.

Embodiments of the above method allows for installation of an agent 140 in an application server without modification of a startup script of the application server, or a restart of the application server. Thus, the installation of agents is improved and disruption times in application server can be avoided. In some implementations, the instrumentation agent 140 may collect performance metrics.

D. Systems and Methods for Injecting Instrumentation Code into a Compiled Mobile Application

Another aspect of the present solution is directed towards injecting instrumentation instructions or code to a compiled mobile application. In some circumstances, source code of a mobile application may not be available or may not include instrumentation or pre-existing functionality that allows reporting the performance metrics of the mobile application. This can be problematic when profiling and measuring performance metrics of mobile applications. The tool of the present solution decompiles the mobile application to source code and identifies one or more classes for instrumentation, thereby bypassing the need for accessing the source code of the mobile application. A selection of one or more of the identified classes may be instrumented. The tool may recompile instrumented source code back into the mobile application, which can be installed and executed on a mobile client 115. When executed, the instrumented code of the mobile application 116 may report instrumentation information, such as code tracing, to a reporting server or a local log file.

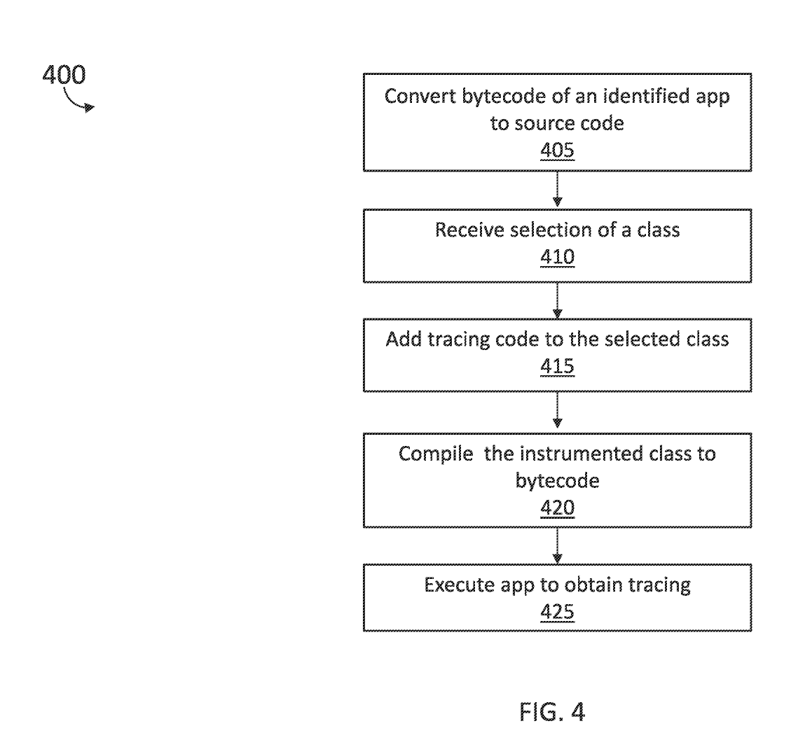

Referring now to FIG. 4, an embodiment of a method of injecting, embedding or deploying instrumentation code into a compiled mobile application is shown. In brief overview, the method includes converting bytecode of an identified application to source code (step 405), receiving a selection of a class to instrument (step 410), and adding instrumented code to the selected class (step 415). The method further includes compiling the instrumented class to the bytecode format of the mobile application (“app”) (step 420), and executing the mobile app to obtaining tracing (step 425).

Still referring to FIG. 4, now in greater detail, the mobile app instrumentation module or tool 160 may receive or identify a mobile application to instrument, such as a compiled mobile application without the original source code The mobile app instrumentation tool may execute on a server and identify the mobile app stored on a client. The mobile app instrumentation tool may execute on a server and identify the mobile app stored or loaded on a server. The mobile app instrumentation tool may execute on a client and identify the mobile app stored on a client.

A decompiler of the mobile app instrumentation tool, converts bytecode of an identified compiled application to source code, such as Java source code with Java classes (step 405). In some implementations, the mobile app instrumentation tool converts machine code to source code. An initial bytecode or an initial archive containing the bytecode may be received and converted. The mobile application may be compiled into an archive file or DEX file. An archive file may be an application packaged (APK) file. A bytecode may be a Dalvick Executable (DEX) file that can be executed by Dalvik Virtual Machines on Android Operating Systems.

In some implementations, the mobile app instrumentation tool may receive the initial bytecode or the initial archive containing the bytecode from a mobile client 115 or a client 110 in order to add instrumented code. In some implementations where an initial archive is received, the mobile app instrumentation tool extracts an archive containing the initial bytecode. In some implementations, the mobile app instrumentation tool may be invoked with the initial bytecode as a parameter. The source code may be in a programming language such as Java, JavaScript, Ruby, Python, C++, etc.

The mobile app instrumentation tool receives a selection of one or more classes to instrument (step 410). The mobile app instrumentation tool may analyze source code to identify a plurality of classes. The mobile app instrumentation tool may present the classes via a user interface to a user for selection. The mobile app instrumentation tool may also present the identified plurality of classes via a user interface to a user for selection. The user may select one or more of the plurality of classes to instrument. The selection may be made by a user via a command line or user interface. The mobile app instrumentation module 160 adds instrumentation code, such as code tracing to the selected classes (step 415). In some implementations, the tracing code may be added via dynamically generating an instrumentation class for the selected class. In some implementations, the instrumentation class may be an aspect class that includes pointcuts, advice, and inter-type declarations. An aspect class, pointcuts, advice, and inter-type declarations are part of aspect-oriented programming paradigm. The instrumentation class may be applied to the extracted Java class. In implementations where the instrumentation class is an aspect, the aspect may weave the advice into one or more places in the selected class matched by the pointcuts. The aspect may also replace one or more static structures and class relationships, as specified by the inter-type declarations. In some implementations, the instrumentation code includes methods or functions for reporting performance metrics to a report server 125 or storing the performance metrics to a local file.

A compiler of the mobile app instrumentation module 160 compiles the source code with instrumentation code, such as via the instrumented classes back to the bytecode (step 420), such as back into the form of the compiled mobile application. In some implementations, compiling the code may include compiling the instrumented class to machine code. The resulting bytecode may be stored in an archive file that is different from the initial archive file. In some implementations where a server received the archive file or the bytecode file, the resulting archive may be transmitted back to a client 110 that has sent the initial bytecode or the initial archive file. In some implementations, the method includes transmitting the resulting archive file of the compiled mobile application back to the mobile client 115, where the resulting archive contains, is or otherwise provides the instrumented mobile app 116.

In some implementations, the instrumented mobile app 116 may be installed on a mobile device (step 425). In some implementations, the bytecode is installed on a mobile device that is simulated on the server as a virtual machine. For example, the bytecode of the compiled mobile application may be executed by or via a virtual machine running in a virtualized environment on a device, such as a server to simulate the running of the instrumented mobile application. Executing and/or exercising or testing the instrumented mobile app in a virtualized environment may enable or allow making sure the instrumentation works and/or did not break any of the mobile application functionality before deploying on a mobile client device. In some implementations, instrumented bytecode may be executed which in turns performs reporting in accordance with the configuration of the instrumentation. The bytecode corresponding to the instrumented code may report instrumentation information or data to the report server 125 or store a report locally. The report may include profiling and performance metric such as execution time of functions, methods, classes, and call stacks.

What is claimed is:

1. A method of instrumenting scripts of webpages, comprising:
intercepting, by an agent, a webpage served by an origin server to a client responsive to receiving a request for the webpage from the client, the webpage comprising one or more scripts;
inserting, by the agent, an instrumentation script within a portion of the webpage prior to execution of the one or more scripts, the instrumentation script configured to embed instrumentation code within the one or more scripts to report on execution of one or more scripts;
executing, upon the client loading the webpage received from the agent, the instrumentation script on the client;
embedding by the instrumentation script, instrumentation code within the one or more scripts; and
storing, by the one or more scripts via execution of the embedded instrumentation code, data to one of a log file or a server to report on execution of the one or more scripts of the webpage.

2. The method of claim 1, wherein the agent resides on one of the origin server, the client or a server intermediary to the client and the origin server and wherein the instrumentation code is configured to provide one or more of tracing, debugging, profiling, performance measurement and data logging of the one or more scripts.

3. The method of claim 1, further comprising:
determining, by the agent, that at least one packet of one or more packets of traffic originating from the origin server to the client satisfies a filter condition,
wherein intercepting the webpage further comprises intercepting the webpage, responsive to determining that the at least one packet of the one or more packets of the traffic satisfies the filter condition.

4. The method of claim 1, further comprising:
determining, by the agent, that the one or more scripts of the webpage includes at least one pre-existing script block; and
embedding the instrumentation code in the at least one pre-existing script block, the instrumentation script configured to compile one of an inline source or source file of the at least one pre-existing script block before execution of the at least one pre-existing script block.

5. The method of claim 1, wherein the instrumentation code is configured to initialize one or more parameters specific to the client, the webpage, the origins server, or the agent.

6. The method of claim 1, wherein executing the instrumentation script further comprises:
parsing the webpage to identify the one or more scripts; and
interpreting the one or more scripts, responsive to identifying the one or more scripts.

7. The method of claim 6, wherein interpreting the one or more scripts further comprises:
identifying a namespace of the respective script in which the instrumentation code is to be called;
responsive to identifying the namespace, replacing a function in the namespace with a wrapper function, the wrapper function configured to record a start time of execution, to call the function, and to record an end time of execution.

8. The method of claim 1, wherein executing the instrumentation script further comprises:
detecting the one or more scripts included in the webpage;
for each of the one or more scripts, detecting a type of the respective script; and
embedding instrumentation code only within respective scripts of a specified type.

9. The method of claim 1, wherein storing the data further comprises storing the data, responsive to determining an occurrence of a triggering event, the triggering event indicating execution of the one or more scripts.

10. The method of claim 1, further comprising embedding instrumentation code within one or more pre-existing script block that specify an external source file by retrieving the external source file and embedding the instrumentation code into the external source file.

11. A system for instrumenting scripts of webpages, comprising:
an agent configured to:
intercept a webpage served by an origin server to a client, responsive to receiving a request for the webpage from the client, the webpage comprising one or more scripts, and to
insert an instrumentation script within a portion of the webpage prior to execution of the one or more scripts, the instrumentation script configured to embed the instrumentation code in the one or more scripts to report on execution of the one or more script; and
wherein the instrumentation script is configured to be executed by the client upon loading of the webpage to embed the instrumentation code within the one or more scripts; and
wherein the instrumentation code is configured upon execution to store data to one of a log file or a server to report on execution of the one or more scripts of the webpage.

12. The system of claim 11, wherein the agent is configured to execute on one of the origin server, the client or a server intermediary to the client and the origin server and wherein the instrumentation code is configured to provide one or more of tracing, debugging, profiling, performance measurement and data logging of the one or more scripts.

13. The system of claim 11, wherein the agent is further configured to:
determine that at least one packet of one or more packets of traffic originating from the origin server to the client satisfies a filter condition,
wherein intercepting the webpage further comprises intercepting the webpage, responsive to determining that the at least one packet of the one or more packets of the traffic satisfies the filter condition.

14. The system of claim 11, wherein the instrumentation script is further configured to:
determine that the one or more scripts of the webpage includes at least one pre-existing script block; and
embed the instrumentation code in the at least one pre-existing script block, the instrumentation script is configured to compile one of an inline source or source file of the at least one pre-existing script block before execution of the at least one pre-existing script block.

15. The system of claim 11, wherein the instrumentation script is configured to initialize one or more parameters specific to the client, the webpage, the origins server, or the agent.

16. The system of claim 11, wherein the instrumentation script is further configured to:
parse the webpage to identify the one or more scripts; and
interpret the one or more scripts, responsive to identifying the one or more scripts.

17. The system of claim 16, wherein the instrumentation script is further configured to interpret the one or more scripts by:
identifying a namespace of the respective script in which the instrumentation code is to be called; and
responsive to identifying the namespace, replacing a function in the namespace with a wrapper function, the wrapper function configured to record a start time of execution, to call the function, and to record an end time of execution.

18. The system of claim 11, wherein the instrumentation script is further configured to:
detect the one or more scripts included in the webpage;
for each of the one or more scripts, detecting a type of the respective script; and
embed the instrumentation code only within respective scripts of a specified type.

19. The system of claim 11, wherein one of the instrumentation script or instrumentation code is configured to store the data responsive to determining an occurrence of a triggering event, the triggering event indicating execution of the one or more scripts.

20. The system of claim 11, wherein the instrumentation script is further configured to embed the instrumentation code within one or more pre-existing script blocks that specify an external source file by retrieving the external source file and embedding the instrumentation code in the external source file.
